(19) United States
(12) Patent Application Publication
(10) Pub. No.: US 2013/0258078 A1
(43) Pub. Date: Oct. 3, 2013

(54) GUIDE DEVICE FOR THE BLIND

(71) Applicants: YU-CHIEN HUANG, Tu-Cheng (TW); GA-LANE CHEN, Santa Clara, CA (US)

(72) Inventors: YU-CHIEN HUANG, Tu-Cheng (TW); GA-LANE CHEN, Santa Clara, CA (US)

(21) Appl. No.: 13/663,382

(22) Filed: Oct. 29, 2012

(30) Foreign Application Priority Data
Mar. 27, 2012 (TW) 101110461

(51) Int. Cl. H04N 7/18

(52) U.S. Cl. 348/62; 348/E07.091

(57) ABSTRACT

A guide device includes a detection module, a processor, and an alarming module. The detection module captures road images in front of a blind person. The processor includes a calculating module and a comparing module. The calculating module calculates an actual height of an obstacle object of the road images. The comparing module compares the actual height with a pre-set critical height. The alarming module reminds the blind person that there is an obstacle object in front of the blind person when the actual height is greater than the critical height.

### BACKGROUND

1. Technical Field

The present disclosure relates to a guide device for the blind.

2. Description of Related Art

Generally, the blind are guided by specially trained guide dogs. However, the guide dogs take a long time and a high cost to train. Thus, the guide dogs are often in short supply.

Therefore, it is desirable to provide a guide device for the blind, which can overcome the limitations described.

### BRIEF DESCRIPTION OF THE DRAWING

FIG. 1 is a schematic view of a guide device used by a blind person in accordance with an exemplary embodiment.

FIG. 2 is a functional block diagram of the guide device of FIG. 1.

### DETAILED DESCRIPTION

Embodiments of the disclosure will now be described in detail, with reference to the accompanying drawings.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash storing system, and hard disk drives.

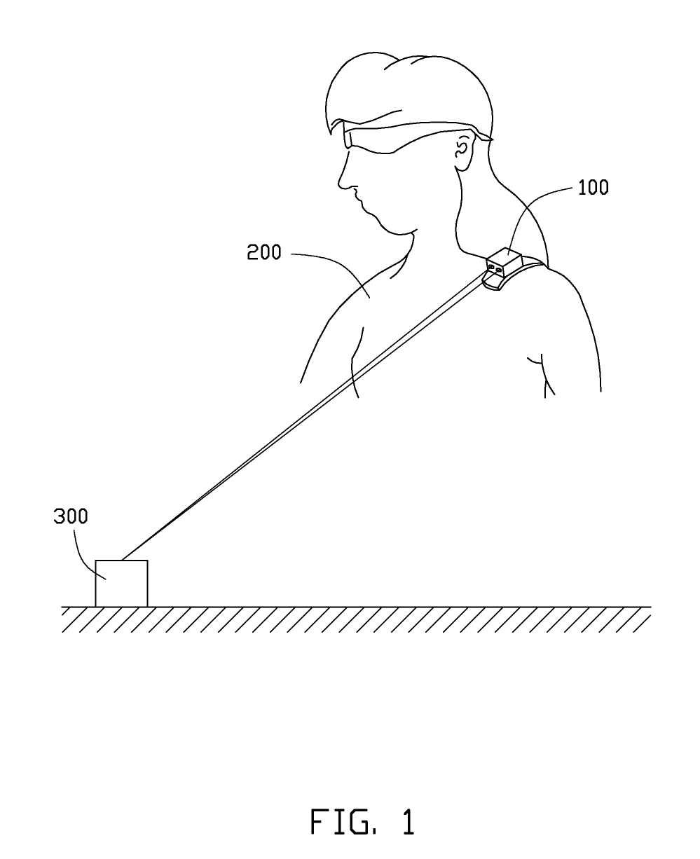

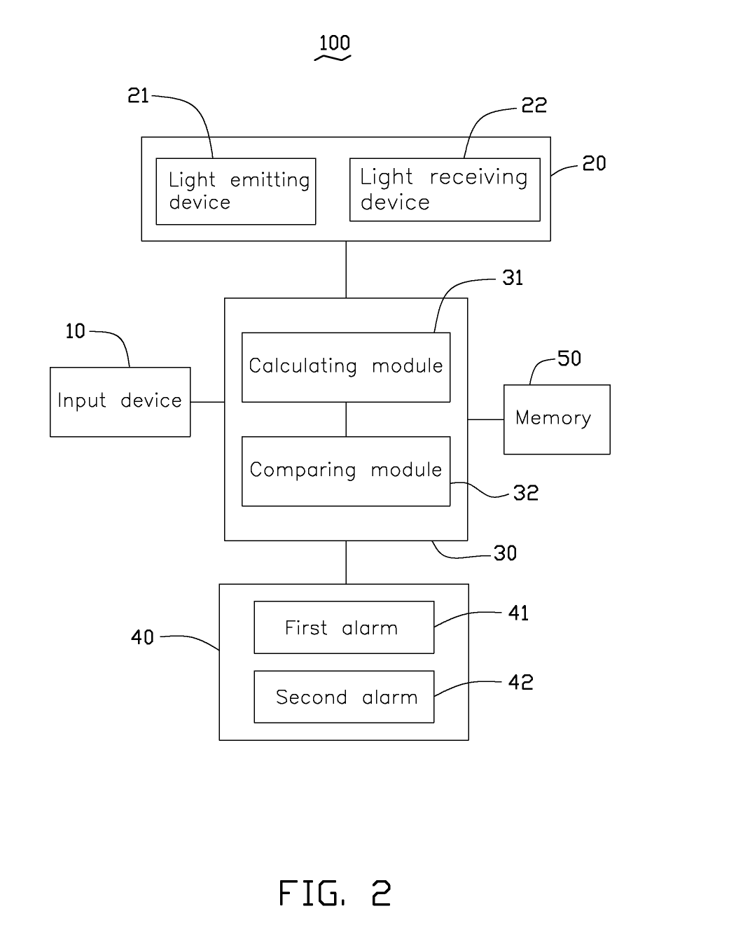

Referring to FIGS. 1-2, a guide device 100, according to an exemplary embodiment, can be used by a blind person 200, and configured for detecting whether or not there is an obstacle object 300 in front of and would obstruct the blind person 200. The guide device 100 includes an input device 10, a detection module 20, a processor 30, an alarming module 40, and a memory 50.

The input device 10 can be but is not limited to a keyboard or a touch panel, and is electrically connected to the processor 30. A critical distance and a critical height are input into the processor 30 via the input device 10. The critical distance can be designed depending on need, and is generally from about 0.5 m to about 1.5 m. The critical height is a vertical distance between a knee and a corresponding foot of a user (e.g. blind person 200), and is generally from about 0.3 m to about 0.7 m.

The detection module 20 includes a light emitting device 21 and a light receiving device 22, and is electrically connected to the processor 30. The light emitting device 21 is an infrared laser configured for emitting infrared lights along a forward direction of the blind person 200. A light intensity of the infrared lights emitted from the light emitting device 21 can be adjusted by the input device 10. The light receiving device 22 is an infrared camera configured for receiving infrared lights reflected by the obstacle object 300 and capturing road images in front of the blind person 200 in real time. The detection module 20 can be manually operated via the input device 10.

The processor 30 includes a calculating module 31 and a comparing module 32 connected to the calculating module 31. The calculating module 31 calculates an actual distance between the blind person 200 and the obstacle object 300 according to the light intensities of the infrared lights emitted from the light emitting device 21 and received by the light receiving device 22, as the light intensity gradually decreases with a traveling distance. The calculating module 31 calculates an actual height of the obstacle object 300 via the road images captured by the light receiving device 22.

The comparing module 32 is configured for comparing the actual distance with the critical distance, and comparing the actual height with the critical height. The comparing module 32 output first signals according to comparing results between the actual distance and the critical distance, and output second signals according to comparing results between the actual height and the critical height.

The alarming module 40 includes a first alarm 41 and a second alarm 42, and is electrically connected to the processor 30. In the embodiment, the first alarm 41 is a buzzer and the second alarm 42 is a sound alarm. The first alarm 41 reminds the blind person 200 that the obstacle object 300 in the forward direction of the blind person 200. The second alarm 42 reminds the blind person 200 to take caution in crossing the obstacle object 300.

The memory 50 is electrically connected to the processor 30. One or more computerized codes of the guide device 100 may be stored in the memory 50 and be executed by the processor 30. The road images captured by the light receiving device 22 are stored in the memory 50.

The blind person 200 turns on the guide device 100 during walking. The light emitting device 21 emits the infrared lights along the forward direction of the blind person 200. The light receiving device 22 receives infrared lights reflected by the blind person 200 and captures road images in the front of the blind person 200 in real time. The calculating module 31 calculates the actual distance according to the light intensities of the infrared lights and the actual height according to the road images. The comparing module 32 compares the actual distance with the critical distance, and compares the actual height with the critical height. If the actual distance is less than the critical distance, the comparing module 32 outputs the first signals to the first alarm 41. The first alarm 41 is activated by the first signals. If the actual height is greater than the critical height, the comparing module 32 outputs the second signals to the second alarm 41. The second alarm 42 is activated by the second signals.

Furthermore, the guide device 100 is inputted a first height less than the critical height and a second height less than the first height via the input device 10. In the embodiment, the first height is about two-thirds of the critical height, and the second height is about one-third of the critical height. The second signals includes a first height signal, a second height signal, a third height signal, and a fourth height signal. In the embodiment, the first height signal, the second height signal, the third height signal, and the fourth height signal are sound signals, but with different volume.

The comparing module 32 compares the actual height with the critical height, the first height, and the second height. If the actual height is greater than the critical height, the comparing module 32 outputs the first height signal. If the actual height is less than the critical height and greater than the first height, the comparing module outputs the second height signal. If the actual height is less than the first height and greater than the second height, the comparing module outputs the third height signal. If the actual height is less than the second height, the comparing module outputs the fourth height signal. The blind person can accurately acquire road condition according to different height signals.

In the embodiment, when the comparing module 32 outputs the first height signal, the second height signal, the third height signal, and the fourth height signal, the second alarm 42 outputs sound with different frequency to remind the blind person.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A guide device, comprising:
a detection module capturing road images in front of a blind person;
a processor, comprising:
a calculating module calculating an actual height of an obstacle object of the road images; and
a comparing module comparing the actual height with a pre-set critical height; and
an alarming module reminding the blind person that it is hard to cross an obstacle object positioned on a forward direction of the blind person when the actual height is greater than the critical height.

2. The guide device of claim 1, further comprising an input device, wherein the critical height is input into the processor via the input device.

3. The guide device of claim 2, wherein a first height less than the critical height and a second height less than the first height are input into the processor via the input device.

4. The guide device of claim 3, wherein the first height is about two-thirds of the critical height, and the second height is about one-third of the critical height.

5. The guide device of claim 4, wherein when the actual height is greater than the critical height, the comparing module outputs a first height signal; when the actual height is less than the critical height and greater than the first height, the comparing module outputs a second height signal; when the actual height is less than the first height and greater than the second height, the comparing module outputs a third height signal; when the actual height is less than the second height, the comparing module outputs a fourth height signal.

6. The guide device of claim 1, wherein a critical distance is input into the processor via the input device.

7. The guide device of claim 6, wherein the detection module comprises a light emitting device and a light receiving device; the light emitting device emits infrared lights along the forward direction of the blind person; the light receiving device receives infrared lights reflected by the obstacle object; the calculating module calculates an actual distance between the obstacle object and the blind person according to light intensities of the infrared lights from the light emitting device and light intensities of the infrared lights received by the light receiving device.

8. The guide device of claim 7, wherein the alarming module reminds the blind person that there is the obstacle object in front of the blind person when the actual distance is less than the critical distance.

9. The guide device of claim 1, further comprising a memory, wherein one or more computerized codes of the guide device are stored in the memory and are capable of being executed by the processor.
